(19) United States
(12) Patent Application Publication
(10) Pub. No.: US 2025/0322029 A1
(43) Pub. Date: Oct. 16, 2025

(54) COMPUTER-READABLE RECORDING MEDIUM HAVING STORED THEREIN PARAMETER IDENTIFICATION PROGRAM, PARAMETER IDENTIFICATION METHOD, AND INFORMATION PROCESSING APPARATUS

(71) Applicant: Fujitsu Limited, Kawasaki-shi (JP)

(72) Inventor: Nasa SONODA(MATSUMOTO), Kawasaki (JP)

(73) Assignee: Fujitsu Limited, Kawasaki-shi (JP)

(21) Appl. No.: 19/077,169

(22) Filed: Mar. 12, 2025

(30) Foreign Application Priority Data
Apr. 12, 2024 (JP) 2024-064914

(51) Int. Cl. G06F 17/11

(52) U.S. Cl. CPC G06F 17/11

(57) ABSTRACT

A computer-readable recording medium having stored therein a parameter identification program causes a computer to execute a process includes generating a probability density function for each of a plurality of parameters used in an optimization algorithm by combining a kernel function generated from a first value of the parameter observed in a given instance, and a kernel function generated from a second value of the parameter identified in each of a plurality of instances. The process includes identifying respective values of the plurality of parameters based on the probability density function generated for the each of the plurality of parameters.

### CROSS-REFERENCE TO RELATED APPLICATION

This application is based upon and claims the benefit of priority of the prior Japanese Patent application No. 2024-064914, filed on Apr. 12, 2024, the entire contents of which are incorporated herein by reference.

### FIELD

The present disclosure relates to a computer-readable recording medium having stored therein a parameter identification program, a parameter identification method, and an information processing apparatus.

### BACKGROUND

Optimization algorithms, such as Simulated Annealing (SA) and Tabu Search (TS), are known as solution approaches for optimization problems, such as combinatorial optimization problems.

In such optimization algorithms, tuning may be performed to appropriately set parameters (e.g., values to parameters), such as hyperparameters, when searching for the optimal solution. In such a tuning process, the optimal values of parameters are identified by repeatedly performing setting and evaluation of values of the parameters for a problem (instance) for which the optimal solution is searched. An example of an approach for tuning parameters is the Tree-structured Parzen Estimator (TPE).

For example, related arts are disclosed in Japanese National Publication of International Patent Application No. 2014-512134, Japanese Laid-open Patent Publication No. 2022-74880, Japanese Laid-open Patent Publication No. 2020-52737, US Patent Application Publication No. 2021/0034928, and US Patent Application Publication No. 2020/0240257.

### SUMMARY

According to an aspect of embodiment(s), a non-transitory computer-readable recording medium having stored therein a parameter identification program that causes a computer to execute the following process. The process may include generating a probability density function for each of a plurality of parameters used in an optimization algorithm by combining a kernel function generated from a first value of the parameter observed in a given instance, and a kernel function generated from a second value of the parameter identified in each of a plurality of instances. The process may also include identifying respective values of the plurality of parameters based on the probability density function generated for the each of the plurality of parameter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a flowchart for explaining an approach for tuning parameters according to a comparative example;

FIG. 2 is a flowchart for explaining one example of a selection process illustrated in FIG. 1;

FIG. 3 is a diagram illustrating one example of the classification of data points;

FIG. 4 is a diagram for explaining a probability density function;

FIG. 5 is a diagram for explaining one example of a kernel density estimation;

FIG. 6 is a diagram illustrating one example of graphs of probability density functions;

FIG. 7 is a diagram for explaining one example of an approach for selecting a candidate point at which the acquisition function is maximized;

FIG. 8 is a block diagram illustrating an example of the hardware configuration of a computer that embodies the functions of an optimization apparatus as one example of one embodiment;

FIG. 9 is a block diagram illustrating an example of the software configuration of the optimization apparatus according to one embodiment;

FIG. 10 is a diagram illustrating one example of the probability density function l(x) calculated by a kernel density estimation unit;

FIG. 11 is a flowchart illustrating an example of the operation of the optimization apparatus according to one embodiment;

FIG. 12 is a diagram illustrating one example of evaluation function values obtained by the approach according to one embodiment; and

FIG. 13 is a diagram illustrating one example of the tuning time by the approach according to one embodiment.

### DESCRIPTION OF EMBODIMENT(S)

The above-described tuning approach has room for improvement in terms of solution performance for optimization problems using parameters identified through tuning or tuning time.

Hereinafter, an embodiment of the present disclosure will be described with reference to the drawings. However, the embodiment described below is merely exemplary, and it is not intended to exclude various modifications or applications of the techniques not explicitly described in the following. For example, various modifications can be made without departing from the scope thereof. In the drawings used in the following description, elements denoted by the like reference symbols denote the same or similar elements, unless otherwise stated.

### (A) Tuning of Parameters

First, the tuning of a plurality of parameters used in an optimization algorithm will be described.

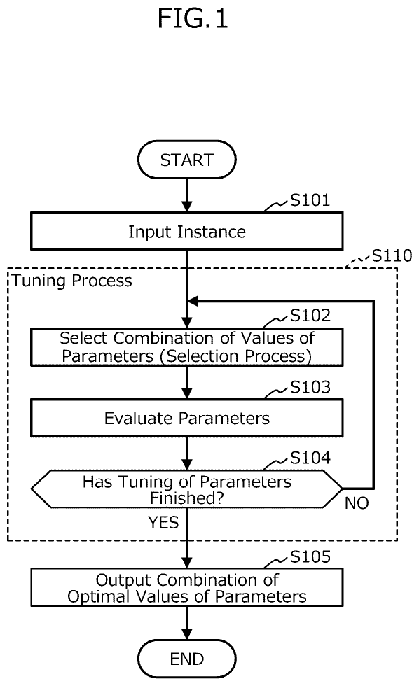

FIG. 1 is a flowchart for explaining an approach for tuning parameters according to a comparative example. In the following, one example of a tuning approach using TPE will be described as a tuning approach according to a comparative example executed by an optimization apparatus that solves an optimization problem. The approach illustrated in FIG. 1 is an approach for determining the optimal combination of values of parameters to be tuned by repeatedly setting and evaluating values of the parameters. The parameters are, for example, hyperparameters.

In Step S101, an instance is input to the optimization apparatus. An instance is a specific example or case of a given problem in an optimization problem. The optimization apparatus performs the parameter tuning process S110 (S102 to S104) for the input instance.

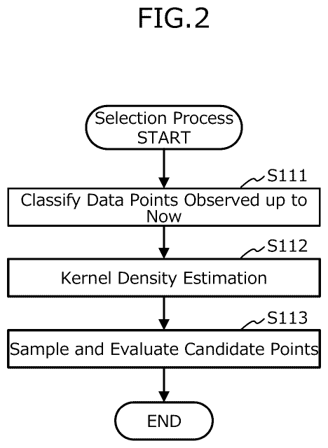

In Step S102, the optimization apparatus performs a selection process to select a value of each of parameters to be tuned from the candidates of values that can be set to the each parameter (the candidates of possible values of the each parameter). In other words, a combination of values of the parameters is selected. The selection process will be described later with reference to FIG. 2.

In Step S103, the optimization apparatus sets the selected combination of values of the plurality of parameters and performs a solution process for the optimization problem for the instance. Based on the execution result, the values of the parameters are evaluated in the selected combination.

In Step S104, the optimization apparatus determines whether or not the tuning of the parameters has been finished. If the tuning has not been finished yet (NO in Step S104), the process proceeds to Step S102. If the tuning has been finished (YES in Step S104), the process proceeds to Step S105. The determination as to whether or not the tuning of the parameters has been finished may be made based on, for example, whether or not the evaluation result (an evaluation function value as one example) meeting the termination criteria is obtained in Step S103, or whether or not a given number of iterations has been performed, etc. The evaluation function value may refer to a value of the function to be optimized (evaluation function).

In Step S105, the optimization apparatus outputs the optimal combination of values of the parameters, e.g., the combination of values of the parameters that has yielded the best result in the parameter evaluation, and the process is terminated.

In Step S102 of FIG. 1, a Bayesian optimization using TPE is executed in the selection process. A Bayesian optimization is a methodology for efficiently determining the maximum value or minimum value of a function with an unknown shape, such as a black-box function, for example.

The optimization apparatus searches for the parameter value that maximizes or minimizes the evaluation value of a function with an unknown shape by repeatedly identifying the point where the evaluation value of the acquisition function is maximized, calculated based on points observed up to now, and selecting this point as the next point to be observed, in Bayesian optimization.

FIG. 2 is a flowchart for explaining one example of the selection process illustrated in FIG. 1. For example, in Step S102 (selection process) in FIG. 1, the optimization apparatus executes a Bayesian optimization for each parameter to be tuned and selects a combination of values of the parameters.

In Step S111, the optimization apparatus classifies (divides) data points observed up to now.

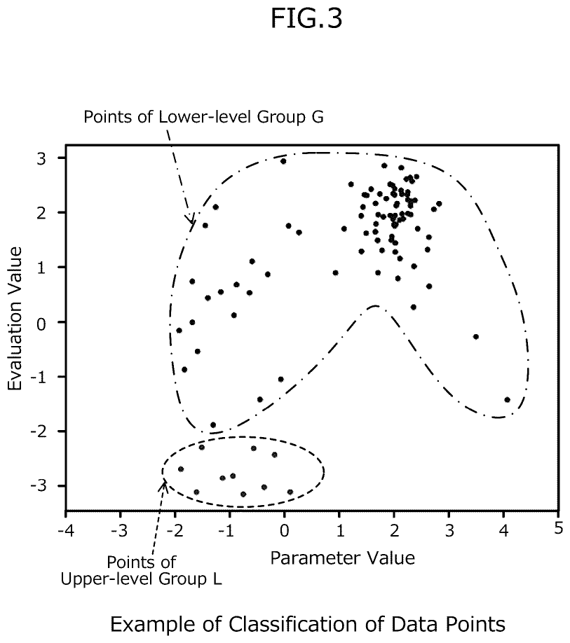

FIG. 3 is a diagram illustrating one example of the classification of data points. The horizontal axis represents parameter values, and the vertical axis represents evaluation values. As exemplified in FIG. 3, the optimization apparatus sorts the data points (parameter values) observed up to now by the evaluation value, e.g., the value of the output variable y, and classifies (divides) them into two groups: the upper-level group L enclosed by the dashed line, and the lower-level group G enclosed by the dashed-dotted line, in an instance currently being executed. In the example of FIG. 3, points with smallest evaluation values, e.g., points ranked in the top 10% of the smallest evaluation values, are classified into the upper-level group L.

In Step S112, the optimization apparatus performs a kernel density estimation to obtain the probability density function.

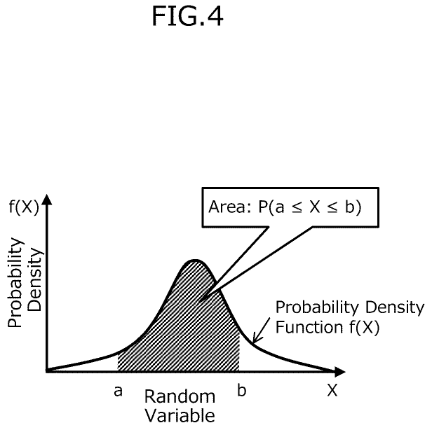

FIG. 4 is a diagram for explaining a probability density function. f(X) represents the probability density function. In FIG. 4, the horizontal axis represents the random variable X, and the vertical axis represents the probability density. A random variable is a quantity determined with a given probability for each trial. For continuous random variables, the product of the probability density and the width of the random variable corresponds to the probability. In the example of FIG. 4, the area enclosed by the probability density function f(X) and the range of the random variable X (a≤x≤b), i.e., the value obtained by integrating the probability density function f(X) with respect to the random variable X (a≤X≤b), is the probability P (a≤x≤b).

For example, assuming that parameters are independent, the optimization apparatus performs a kernel density estimation for each parameter for both the upper-level group L and the lower-level group G to calculate the probability density function l(x) for the upper-level group L and the probability density function g(x) for the lower-level group G, where x represents the value of a given parameter.

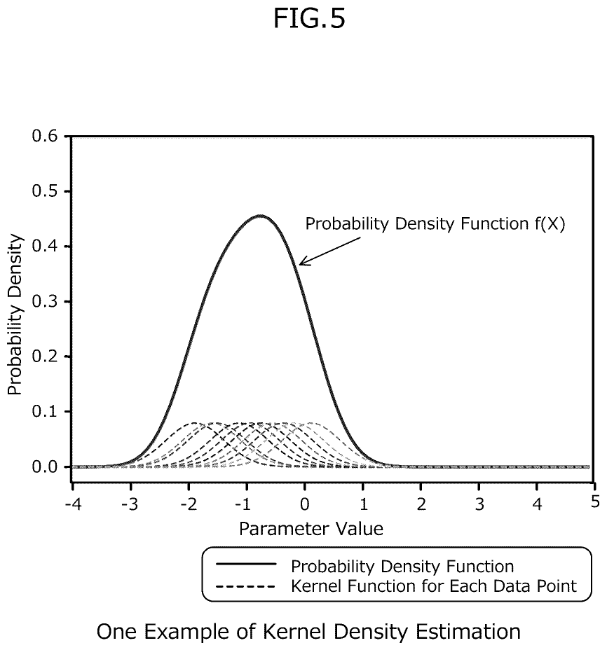

FIG. 5 is a diagram for explaining one example of a kernel density estimation. The horizontal axis represents parameter values, and the vertical axis represents probability density. In FIG. 5, the curves drawn by the dashed lines represent the kernel function for each data point, and the curve drawn by the solid line represents the probability density function f(x) as one example of the probability density function l(x) or g(x). In kernel density estimation, the optimization apparatus generates a kernel function for each data point and estimates the probability density function f(x) by summing the resultant kernel functions.

One example of a kernel function is a Gaussian function. When a Gaussian function is used as the kernel function and weights are given to each kernel, f(x) can be expressed by the following expression (1), for example.

$$f ( x ) = \frac{1}{{\sum }_{i = 1}^{n} {w}_{i}} \{ {\sum }_{i = 1}^{n} {w}_{i} \frac{1}{\sqrt{2 π} h} exp ( - \frac{{( x - {x}_{i} )}^{2}}{2 {h}^{2}} ) \} \qquad ( 1 )$$

In the above expression (1), n is the number of data points, wᵢ is the weight for each kernel function, xᵢ is the value of each data point, and h is the bandwidth. Although the bandwidth h is fixed in FIG. 5, a different bandwidth may be determined for each kernel function, for example, the bandwidth may be determined according to the distance to adjacent data points. In the probability density function f(x) of the above expression (1), the numerical value in the curly brackets determined by summing the Gaussian function when the variable i is varied from 1 to n is multiplied by 1/[the sum of weights wᵢ when i is varied from 1 to n] so that the result of the integration equals 1.

In Step S113, the optimization apparatus performs sampling and evaluation of candidate points for each of the probability density functions l(x) and g(x) obtained through the kernel density estimation in Step S112.

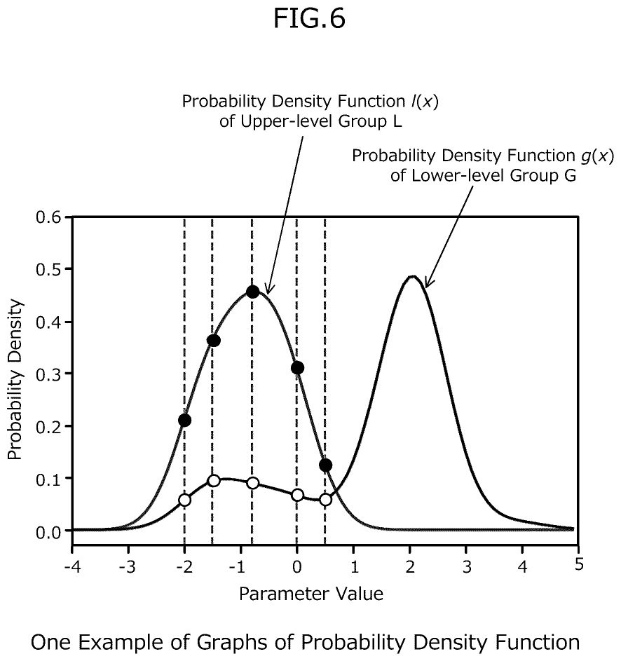

FIG. 6 is a diagram illustrating one example of the graphs of the probability density functions l(x) and g(x). The horizontal axis represents parameter values, and the vertical axis represents probability density. The optimization apparatus samples a plurality of parameter values x that follow the probability density function l(x) as candidate points x⁺ (see the black circles) and selects the point at which the acquisition function is maximized from the plurality of candidate points x⁺.

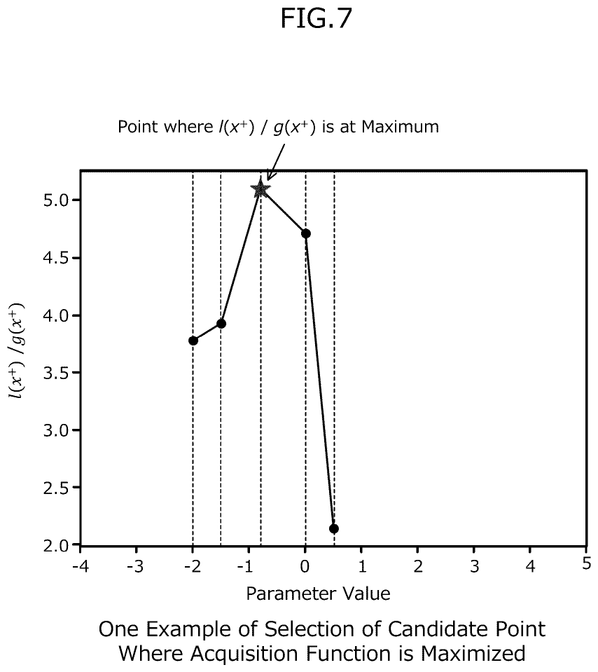

FIG. 7 is a diagram for explaining one example of an approach for selecting a candidate point at which the acquisition function is maximized. In FIG. 7, one example of the graph of l(x⁺)/g(x⁺) is illustrated. The horizontal axis represents parameter values, and the vertical axis represents l(x⁺)/g(x⁺). For example, in the case where TPE is used, the optimization apparatus may select (determine) x⁺ where l(x⁺)/g(x⁺) is maximized in order to maximize the acquisition function. Here, l(x⁺) represents the values of the probability density function l(x) at the candidate points x⁺, i.e., the probability densities (see the black circles in FIG. 6), and g(x⁺) represents the value of the probability density function g(x) at the candidate points x⁺, i.e., the probability densities (see the white circles in FIG. 6). In the example of FIG. 7, the optimization apparatus selects “−0.8” as the parameter value.

In tuning approaches, it is important to find a more appropriate combination of values of parameters to improve the quality of the solution for enhancing the solution performance of the optimization apparatus. It is also important to suppress degradation in the quality of the solution or to improve the quality of the solution while shortening the tuning time. The above-described tuning approach has room for improvement in terms of solution performance for optimization problems using parameters identified through tuning or in terms of tuning time.

Therefore, in one embodiment, an approach for efficiently identifying the values of a plurality of parameters used in an optimization algorithm will be described.

### (B) Example of Configuration of Optimization Apparatus According to One Embodiment

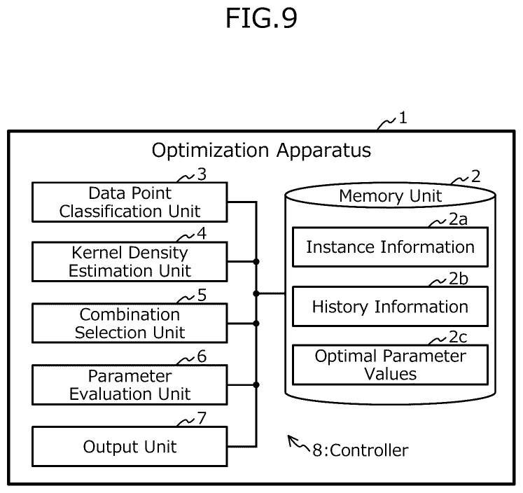

Hereinafter, an example of the configuration of an optimization apparatus 1 according to one embodiment (see FIG. 9) will be described.

### (B-1) Example of Hardware Configuration

The optimization apparatus 1 according to one embodiment may be a virtual server (virtual machine, VM) or a physical server. Furthermore, the functions of the optimization apparatus 1 may be embodied by a single computer or by two or more computers. Moreover, at least a part of the functions of the optimization apparatus 1 may be embodied using hardware (HW) resources and network (NW) resources provided by a cloud environment.

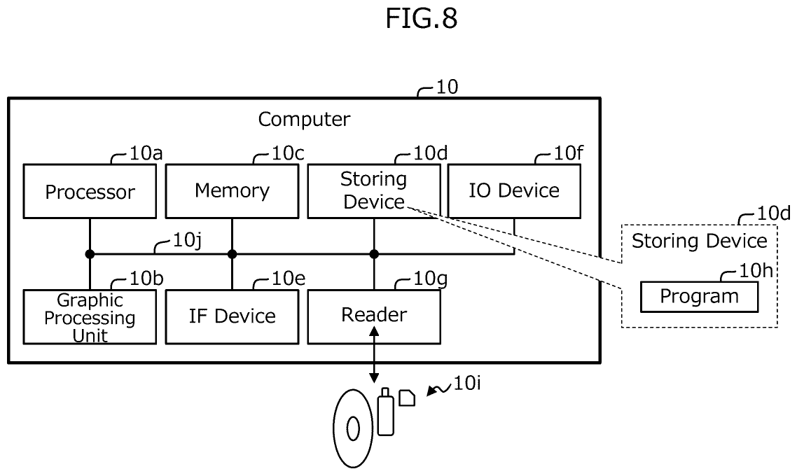

FIG. 8 is a block diagram illustrating an example of the hardware (HW) configuration of a computer 10 that embodies the functions of the optimization apparatus 1 as one example of one embodiment. When multiple computers are used as HW resources to embody the functions of the optimization apparatus 1, each computer may include the HW configuration illustrated in FIG. 8.

As illustrated in FIG. 8, the computer 10 may include, as an example, a processor 10a, a graphic processing unit 10b, a memory 10c, a storing device 10d, an interface (IF) device 10e, an input/output (IO) device 10f, and a reader 10g, as the HW configuration.

The processor 10a represents one example of a processing device that performs various control and computation operations. The processor 10a may be communicably connected to each block in the computer 10 via a bus 10j. The processor 10a may be a multiprocessor having a plurality of processors, may be a multicore processor having a plurality of processor cores, or may be configured to have a plurality of multicore processors.

Examples of the processor 10a include integrated circuits (ICs), such as a CPU, MPU, APU, DSP, ASIC, or FPGA, for example. Note that two or more combinations of these integrated circuits may be used for the processor 10a. CPU is an abbreviation for Central Processing Unit, and MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The graphic processing unit 10b controls screen displays to an output device such as a monitor, which is a part of the IO unit 10f. Additionally, the graphic processing unit 10b may be configured as an accelerator that performs at least one of machine learning processes and inference processes using machine learning models. Examples of the graphic processing unit 10b include various arithmetic processing units, such as integrated circuits (ICs), e.g., a graphic processing unit (GPU), APU, DSP, ASIC, or FPGA.

The memory 10c and storing unit 10d each store information, such as various types of data and programs. Examples of the memory 10c include at least one of volatile memory, such as dynamic random access memory (DRAM), and non-volatile memory, such as persistent memory (PM), for example. Examples of the storing device 10d include various storing devices such as magnetic disk devices, e.g., a hard disk drive (HDD), semiconductor drive devices, e.g., a solid state drive (SSD), and non-volatile memory. Examples of non-volatile memory include flash memory, storage class memory (SCM), and read only memory (ROM), for example.

The storing device 10d may store a program 10h (parameter identification program) for embodying all or a part of the various functions of the computer 10. For example, the processor 10a of the optimization apparatus 1 may embody the functions of the controller 8 (see FIG. 9) described later by loading the program 10h stored in the storing unit 10d into the memory 10c and executing the program 10h.

The IF unit 10e represents one example of a communication IF that controls, etc. connections and communications between the optimization apparatus 1 and other computers. For example, the IF device 10e may include an adapter that is compliant with electronic communications, such as Ethernet® (e.g., a local area network (LAN)), or optical communications, such as Fibre Channel (FC), etc. This adapter may support either or both of wireless and wired communication methods. Note that the program 10h may be downloaded from a network to the computer 10 via the communication IF and stored in the storing device 10d.

The IO device 10f may include either or both of an input device and an output device. Examples of the input device include a keyboard, a mouse, and a touch panel, for example. Examples of the output device include a monitor, a projector, and a printer, for example. The IO device 10f may also include a touch panel that integrates an input device and an output device. The output device may be connected to the graphic processing unit 10b.

The reader 10g represents one example of a reader that reads information, such as data and programs recorded on a storage medium 10i. The reader 10g may include a connection terminal or device to which the storage medium 10i can be connected or inserted. Examples of the reader 10g include adapters that are compliant with standards, such as Universal Serial Bus (USB), drive devices that access recording disks, and card readers that access flash memory, such as SD cards, for example. Note that the program 10h may be stored in the storage medium 10i, and the reader 10g may read the program 10h from the storage medium 10i and store the program 10h in the storing device 10d.

Examples of the storage medium 10i include, as an example, non-transitory computer-readable recording medium such as magnetic/optical disks and flash memory. Examples of the magnetic/optical disks include, as an example, flexible disks, compact discs (CDs), digital versatile discs (DVDs), Blu-ray discs, and holographic versatile discs (HVDs). Examples of the flash memory include semiconductor memory devices such as USB memory and SD cards.

The HW configuration of the computer 10 described above is exemplary. Accordingly, HW components may be added or deleted (any block may be added or deleted, for example), divided, integrated in any combination, or buses may be added or deleted, in the computer 10 as appropriate.

### (B-2) Example of Software Configuration

FIG. 9 is a block diagram illustrating an example of the software configuration of the optimization apparatus 1 according to one embodiment. The optimization apparatus represents one example of a computer or an information processing apparatus and represents one example of a parameter identification apparatus that executes a parameter identification process to identify values of a plurality of parameters used in an optimization algorithm. The plurality of parameters are one example of parameters used to search for a solution for a given instance using an optimization algorithm. Additionally, the optimization apparatus 1 may execute a solution process for an optimization problem, such as a combinatorial optimization problem, for an instance.

In the following description, the optimization apparatus 1 is assumed to execute a solution process for an optimization problem for an instance using parameters, e.g., hyperparameters, identified through a parameter identification process. However, this is not limiting. For example, the optimization apparatus 1 may also be an apparatus that executes only parameter identification processes among parameter identification processes and solution processes, and may output (provide) identified parameters to another optimization apparatus that executes solution processes.

As exemplified in FIG. 9, the optimization apparatus 1 includes a memory unit 2, a data point classification unit 3, a kernel density estimation unit 4, a combination selection unit 5, a parameter evaluation unit 6, and an output unit 7. The data point classification unit 3, the kernel density estimation unit 4, the combination selection unit 5, the parameter evaluation unit 6, and the output unit 7 represent one example of a controller 8. Note that the controller 8 may execute solution processes for optimization problems. The functions of the controller 8 may be embodied, for example, by the processor 10a in the computer 10 illustrated in FIG. 8 which executes the program 10h loaded into the memory 10c.

The memory unit 2 stores various data used for executing parameter identification processes by the optimization apparatus 1. For example, the memory unit 2 may store instance information 2a, history information 2b, and optimal parameter values 2c. The memory unit 2 may be embodied, for example, by storage areas in either or both of the memory 10c and storing unit 10d in the computer 10 illustrated in FIG. 8.

The instance information 2a is information about an instance for which the optimal solution is sought (to be searched), and represents one example of a given instance. The instance information 2a is, for example, information indicating a specific example or case of a certain problem in an optimization problem, in other words, information indicating the conditions for the solution process for the optimization problem.

The history information 2b includes results in the past (experimental results), e.g., the tuning results of parameters for a plurality of instances executed in the past before the given instance. The history information 2b includes, for example, values of a plurality of parameters (hyperparameters) (a combination of values of parameters) identified in the tuning processes for each of the plurality of instances. Note that the plurality of instances may be a plurality of instances (similar instances) that belong to a common field but may differ from each other in terms of problems (optimization problems) and the solutions obtained by solving those problems. Examples of fields include, as one example, information technology (IT)-driven drug discovery.

The parameter tuning processes executed in the past stored in the history information 2b may employ the approach according to one embodiment or other approaches (e.g., the approach according to the comparative example), and these approaches may be employed in combination. Moreover, the history information 2b may be calculated by the optimization apparatus 1 or by other optimization apparatuses.

The optimization apparatus 1 (controller 8) may receive, for example, at least one of the instance information 2a and the history information 2b from another computer (not illustrated) via the IF unit 10e and a network and store the received information in a storage area.

In a tuning process of parameters, the controller 8 repeatedly executes the setting and evaluation of values of a plurality of parameters to be tuned, to thereby identify the optimal combination of values of parameters for a problem (instance) for which the optimal solution is searched.

The data point classification unit 3, the kernel density estimation unit 4, and the combination selection unit 5 execute a selection process to select a value of each of parameters to be tuned from the candidates of values that can be set to the each parameter (the candidates of possible values of the each parameter).

The data point classification unit 3 classifies (divides) the data points observed up to now, in the iterative process. For example, as illustrated in FIG. 3, in an instance currently being executed, the data point classification unit 3 sorts the data points observed up to now by the evaluation value, e.g., by the value of the output variable y, and classifies them into two groups: the upper-level group L (e.g., points ranked in the top 10% of the evaluation values) enclosed by the dashed line and the lower-level group G enclosed by the dashed-dotted line.

The kernel density estimation unit 4 performs a kernel density estimation based on the instance currently being executed indicated by the instance information 2a and a plurality of instances in the past indicated by the history information 2b, to obtain the probability density function.

For example, as illustrated in FIG. 5, the kernel density estimation unit 4 may generate a kernel function for each of data points in the lower-level group G among data points observed in the instance currently being executed, and calculate the probability density function g(x) by summing the resultant kernel functions.

In addition, the kernel density estimation unit 4 performs the follow process in the calculation of the probability density function l(x). The kernel density estimation unit 4 generates a kernel function x for each of values of the parameters (first values), e.g., each data point in the upper-level group L (see FIG. 5), observed in the instance currently being executed. Moreover, the kernel density estimation unit 4 generates a kernel function β for each of a plurality of values of the parameters (a plurality of second values) identified in a plurality of instances in the past. The kernel density estimation unit 4 then generates the probability density function l(x) of the parameters by combining the kernel functions α and β according to given weights.

Here, in the kernel density estimation in TPE as illustrated in FIG. 5 (see Step S112 in FIG. 2), kernel functions are generated from the data points observed in the instance currently being executed, and the probability density function is calculated by summing the resultant kernel functions.

In contrast, the kernel density estimation unit 4 utilizes a plurality of values of the parameters identified in a plurality of instances in the past, in addition to the instance currently being executed, to generate the probability density function l(x). By capturing trends from the plurality of instances in the past in this manner, the values of the parameters that have been evaluated as optimal in the tuning of the plurality of instances in the past, for example, can be utilized in the generation of the probability density function l(x).

As a result, hyperparameters can be efficiently tuned, leading to an improvement in the quality of the solution. Moreover, the improvement in the quality of the solution can reduce the number of searches for combinations of hyperparameter values, e.g., the loop count in Steps S102 to S104 illustrated in FIG. 1, thereby achieving the reduction in tuning time.

The combination selection unit 5 performs sampling and evaluation of candidate points for each of the probability density functions l(x) and g(x) obtained by the kernel density estimation unit 4 to select a combination of values of the parameters. For example, as illustrated in FIG. 6, the combination selection unit 5 samples a plurality of parameter values x that follow the probability density function l(x) as candidate points x⁺ (see the black circles) and selects (identifies) x⁺ at which the acquisition function is maximized, e.g., x⁺ at which 1 (x⁺)/g(x⁺) is maximized, among the plurality of candidate points x⁺. The combination selection unit 5 outputs the selected respective values x⁺ for the parameters as a combination of parameter values.

The parameter evaluation unit 6 evaluates the parameters based on the combination of values of the parameters selected through the selection process. For example, the parameter evaluation unit 6 sets the values of the plurality of parameters according to the selected combination, executes the solution process the for optimization problem for the instance, and evaluates the parameters in the selected combination based on the execution result. Note that the tuning process performed by the parameter evaluation unit 6 may be similar to the process for evaluating parameters (Step S103) illustrated in FIG. 1, for example.

The output unit 7 outputs (stores) the respective values of the plurality of parameters identified by the parameter evaluation unit 6 as the optimal parameter values 2c in the memory unit 2. The optimal parameter values 2c are a combination of optimal values of the parameters and are, for example, used as setting values for hyperparameters when a solution process for an optimization problem is executed. Note that the output unit 7 may send the optimal parameter values 2c to other computers (not illustrated) via the IF unit 10e and a network.

### (C) Explanation of Kernel Density Estimation Unit

Next, the details of the kernel density estimation process performed by the kernel density estimation unit 4 will be described. First, as a comparative example, an example of calculation of the probability density function l(x) calculated from the kernel function of an instance currently being executed using the approach by TPE is expressed in the following expression (2).

$$l ( x ) = \frac{1}{{\sum }_{i = 1}^{n} {w}_{1 i}} \{ {\sum }_{i = 1}^{n} {w}_{1 i} \frac{1}{\sqrt{2 π} h} exp ( - \frac{{( x - {x}_{i} )}^{2}}{2 {h}^{2}} ) \} \qquad ( 2 )$$

In order to capture the trends from a plurality of instances in the past described above in the calculation of the probability density function l(x), the kernel density estimation unit 4 may calculate the probability density function l(x) according to the calculation formula expressed in the following expression (3), for example.

$$l ( x ) = \frac{1}{{\sum }_{i = 1}^{n} {w}_{1 i} + {\sum }_{j = 1}^{m} {w}_{2 j}} \{ {\sum }_{i = 1}^{n} {w}_{1 i} \frac{1}{\sqrt{2 π} h} exp ( - \frac{{( x - {x}_{i} )}^{2}}{2 {h}^{2}} ) + {\sum }_{j = 1}^{m} {w}_{2 j} \frac{1}{\sqrt{2 π} h} exp ( - \frac{{( x - {x}_{j} )}^{2}}{2 {h}^{2}} ) \} \qquad ( 3 )$$

In the above expressions (2) and (3), x represents the value of a given parameter, i.e., a data point. n represents the number of data points observed in an instance currently being executed, i.e., the instance for which the optimal solution is to be searched. w₁ᵢ is a weight given (e.g., multiplied) to each data point observed in the instance currently being executed, and represents one example of a first weight. xᵢ represents the parameter value at each data point. h is the bandwidth.

In the above expression (3), m represents the number of instances in the past. w₂ⱼ is a weight given (e.g., multiplied) to each instance in the past and represents one example of a second weight. xⱼ is the optimal parameter value tuned in each of the plurality of instances in the past and represents one example of a second value. In the above expression (3), the part expressed in the following expression (4) represents one example of the kernel function α, and the part expressed in the following expression (5) represents one example of the kernel function β.

$$Kernel Function α = \frac{1}{\sqrt{2 π} h} exp ( - \frac{{( x - {x}_{i} )}^{2}}{2 {h}^{2}} ) \qquad ( 4 )$$

$$Kernel Function β = \frac{1}{\sqrt{2 π} h} exp ( - \frac{{( x - {x}_{j} )}^{2}}{2 {h}^{2}} ) \qquad ( 5 )$$

In the above expression (4), the kernel function α is generated from the data points x (parameter values, first values) observed in the instance currently being executed, e.g., data points included in the upper-level group L. In the above expression (5), the kernel function β is generated using the optimal parameter values (second values) xⱼ tuned (identified) in the instances in the past.

In the above expressions (3) to (5), the expression (3) represents one example of a calculation formula that includes a plurality of kernel functions α generated based on a plurality of values x of parameters observed in a given instance and a plurality of kernel functions β generated based on a plurality of values xⱼ of the parameters identified in a plurality of instances in the past. For example, in the curly brackets in the above expression (3), the sum of the products obtained by multiplying each of the kernel functions α by the weight w₁ᵢ and the sum of the products obtained by multiplying each of the kernel functions β by the weight w₂ⱼ are calculated. In the above expression (3), the numerical value in the curly brackets is multiplied by 1/[(the sum of weights w₁ᵢ when the variable i is varied from 1 to n)+(the sum of weights w₂ⱼ when the variable j is varied from 1 to m)] so that the result of the integration equals 1.

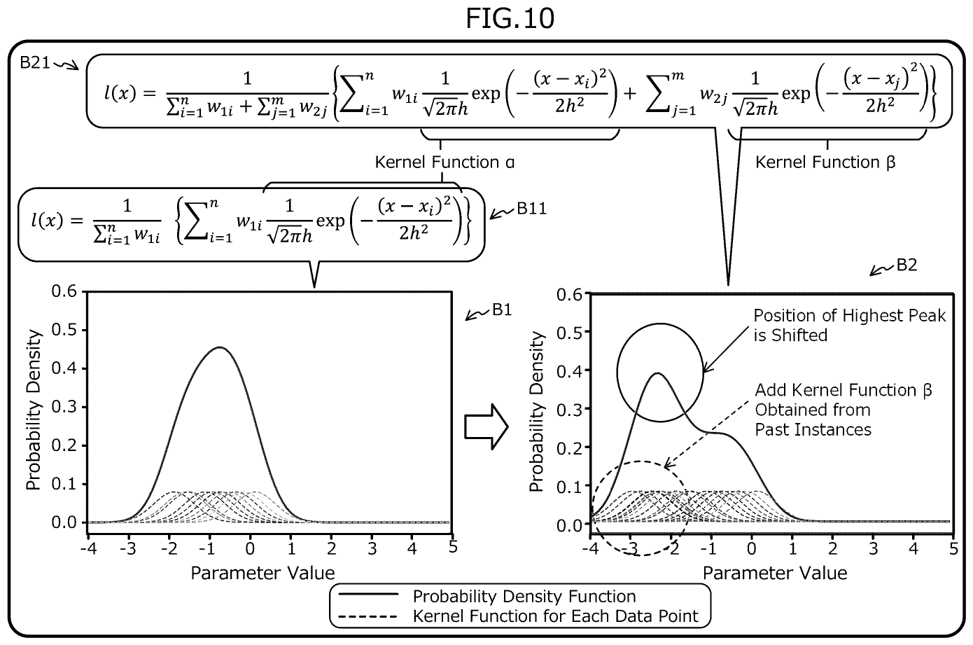

FIG. 10 is a diagram illustrating one example of the probability density function l(x) calculated by the kernel density estimation unit 4. The symbol B1 in FIG. 10 denotes the graph of the probability density function l(x) calculated from the kernel functions of an instance currently being executed according to the expression (2) (see the symbol B11) by the approach of TPE, for example, as a comparative example. The symbol B2 in FIG. 10 denotes the graph of the probability density function l(x) calculated by the kernel density estimation unit 4 from the kernel functions α of the instance currently being executed and the kernel functions β of instances in the past according to the expression (3) (see the symbol B21).

According to the kernel density estimation unit 4, as denoted by the dashed-line circle in the graph of the symbol B2, the kernel functions β obtained from instances in the past are used, in addition to the kernel functions α (see the graph of the symbol B1), in the calculation of the probability density function l(x).

As a result, as denoted by the solid-line circle in the graph of the symbol B2, the parameter value corresponding to the position of the highest peak (data point) in the graph of the probability density function l(x), i.e., the parameter value where the maximum probability density is obtained, is shifted from the peak in the graph denoted by the symbol B1. In TPE, the position of the highest peak in the graph of the probability density function l(x) becomes more likely to be selected as the next parameter value. Accordingly, the parameter value selected for the instance currently being executed can be adjusted using the parameter values determined to be optimal in instances in the past, contributing to improved problem-solution performance.

### (C-1) Explanation of Approach for Determining Weights

The above expression (3) includes the weight w₁ᵢ to be multiplied by the kernel function α and the weight w₂ⱼ to be multiplied by the kernel function β. In the following, one example of the approach for determining each of the weights w₁ᵢ and w₂ⱼ will be described.

The weight w₁ᵢ is similar to the weight w₁ᵢ included in the above expression (2) (or the weight wᵢ included in the above expression (1)). For example, the kernel density estimation unit 4 may determine the weight w₁ᵢ so that a smaller weight w₁ᵢ is assigned to a kernel function x associated with older data.

The weight w₂ⱼ is adjusted so that the probability density function l(x) is not overly influenced by instances in the past. For example, the kernel density estimation unit 4 may determine the weight w₂ⱼ according to the number m of kernel functions β obtained when the kernel functions β are generated and the initial number N of kernel functions α obtained when the kernel functions α are generated.

The initial number N is the number of candidate points determined randomly during the initial phase of parameter tuning. During the initial phase, because the number of data points observed up to now is too small, the controller 8 determines candidate points randomly instead of using the “number of data points observed up to now” employed in the approach of TPE. The kernel density estimation unit 4 sets the number of candidate points determined randomly during the initial phase to the initial number N.

During the initial phase of parameter tuning, the above expression (3) is modified by substituting the initial number N for the number n of data points observed in the instance currently being executed, as expressed in the following expression (6).

$$l ( x ) = \frac{1}{{\sum }_{i = 1}^{N} {w}_{1 i} + {\sum }_{j = 1}^{m} {w}_{2 j}} \{ {\sum }_{i = 1}^{N} {w}_{1 i} \frac{1}{\sqrt{2 π} h} exp ( - \frac{{( x - {x}_{i} )}^{2}}{2 {h}^{2}} ) + {\sum }_{j = 1}^{m} {w}_{2 j} \frac{1}{\sqrt{2 π} h} exp ( - \frac{{( x - {x}_{j} )}^{2}}{2 {h}^{2}} ) \} \qquad ( 6 )$$

In the above expression (6), the number of kernel functions α added in the first term in the curly brackets is the initial number N, and the number of kernel functions β added in the second term in the curly brackets is the number m. If the number m of kernel functions β is too large compared to the initial number N of kernel functions α, the probability density function l(x) might be overly influenced by instances in the past. In this case, the possibility of the combination of parameter values obtained through tuning using the probability density function l(x) is optimal for the instance currently being executed may decrease.

To address this issue, the kernel density estimation unit 4 may set the value indicated by the following expression (7) to the weight w₂ⱼ, for example.

$${w}_{2 j} = \frac{N}{k * m} \qquad ( 7 )$$

In the above expression (7), k is an adjustment coefficient. For example, an experiment where N=10, m=27, and k=2 confirmed that the probability density function l(x) was adjusted not to be overly influenced by instances in the past, demonstrating the effectiveness of setting the weight w₂ⱼ according to the above expression (7).

### (C-2) Explanation of Patterns of Setting Weight

The value of the weight w₂ⱼ for kernel functions β for one instance may be kept constant during the tuning process or may be varied as the tuning process progresses. The kernel density estimation unit 4 may set the weight w₂ⱼ according to any of the following patterns (i) to (iv), for example.

### (i) First Pattern

The kernel density estimation unit 4 may always set the weight w₂ⱼ according to the above expression (7) during the tuning process of parameters. Since the weight w₂ⱼ is set to a fixed value during the tuning process for one instance currently being executed, an increase in the processing load of the optimization apparatus 1 can be reduced and the processing time can be shortened.

### (ii) Second Pattern

The kernel density estimation unit 4 may adjust the value of the weight w₂ⱼ according to the priority (importance) of each of the plurality of instances in the past. For example, the kernel density estimation unit 4 may apply gradation (may assign higher or lower values) to the weight w₂ⱼ among the plurality of instances in the past. As one example, the kernel density estimation unit 4 may assign higher priorities to instances with more recent execution timings, and set a larger value for the weight w₂ⱼ for instances with higher priorities, among a plurality of instances in the past.

Hereinafter, instances with execution timings relatively closer to the current time may be referred to as “new instances,” while instances with execution timings relatively farther from the current time may be referred to as “old instances”, among a plurality of instances in the past.

For example, in the above expression (3) or (6), the instance selected according to the value of the variable j is assumed to be older as the value of j is smaller and newer as the value of j is larger. In this case, the kernel density estimation unit 4 may set a smaller value to the weight w₂ⱼ as the value of variable j decreases and set a larger value as the value of variable j increases according to the following expression (8), for example.

$${w}_{2 j} = \frac{N}{k * m} * c * j \qquad ( 8 )$$

In the above expression (8), c is an adjustment coefficient. In cases where the instance selected according to the value of the variable j is older as the value of j is larger and newer as the value of j is smaller, the above expression (7) is divided by the variable j instead of multiplying the above expression (7) by j, in the above expression (8). Alternatively, in cases where the value of variable j does not correspond to the execution timing of instances, another variable indicating the execution order of the instances may be used in place of the variable j.

In this way, the probability density function l(x) is set to be more influenced by instances with higher priorities than instances with lower priorities among a plurality of instances in the past, increasing the likelihood of selecting more appropriate parameter values. For example, by giving higher priorities to newer instances, more appropriate recent trends in parameter values can be captured into the probability density function l(x) at a higher ratio. Information for identifying the execution timing of

a plurality of instances in the past may be included in the history information 2b, for example. Such information may include, for example, data indicating the execution timing of instances, such as timestamps, or information specifying the execution order of multiple instances, such as serial (sequential) numbers.

Note that the above description has been made with reference to the example where the priority is set based on the recency of the instances, but this is not limiting. The priority may be set based on various pieces of information that enable a plurality of instances in the past to be ranked or categorized.

As one example, the priority may be set based on the similarity between the instance currently being executed and each of the plurality of instances in the past, and instances more similar to the instance currently being executed are given higher priorities. This enables more appropriate parameter values identified in instances with higher similarities to the instance currently being executed to be captured into the probability density function l(x) at a higher ratio. When the controller 8 obtains the instance information 2a, the controller 8 may calculate the similarity between the instance information 2a and each of the plurality of instances included in the history information 2b, for example. The calculation of the similarity can be embodied by various known approaches.

(iii) Third Pattern

The kernel density estimation unit 4 may adjust the value of the weight w₂ⱼ according to the number n of kernel functions α. For example, when the number n of kernel functions α is less than or equal to a given threshold, the kernel density estimation unit 4 may set the weight w₂ⱼ according to the expression (7), in a manner similar to the first pattern. On the other hand, when the number n of kernel functions α exceeds the given threshold, the kernel density estimation unit 4 may set the weight w₂ⱼ to a value larger than the value determined according to the above expression (7). As an example, the kernel density estimation unit 4 may set the weight w₂ⱼ according to the following expression (9).

$${w}_{2 j} = \{ \begin{matrix}\frac{N}{k * m} & ( n \leq Th ) \\ \frac{N}{k * m} * d & ( n > Th )\end{matrix} \qquad ( 9 )$$

In the above expression (9), d is an adjustment coefficient. Th is a given threshold used to determine whether or not the situation in which the number m of kernel functions β is excessively larger than the number n of kernel functions α (initial number N) has been resolved, and may be set, for example, based on the initial number N of kernel functions α and the number m of kernel functions β.

In this manner, when the situation where the number m of kernel functions β is excessively larger than the number n of kernel functions α (initial number N) is resolved as the tuning process progresses, the kernel density estimation unit 4 sets the value of the weight w₂ⱼ to a value larger than the value used before the situation has been resolved. This allows optimal parameter values from instances in the past to be captured into the probability density function l(x) at an appropriate ratio, according to the number n of kernel functions α.

Although an example where the weight w₂ⱼ can take two values according to the result of the comparison between the number n of kernel functions α and the threshold Th has been demonstrated in the above expression (9), this is not limiting. For example, the adjustment coefficient d may be a variable that is varied according to the value of the number n of kernel functions α. Alternatively, instead of the threshold Th and the adjustment coefficient d, a plurality of, e.g., p (p is an integer of 2 or greater) thresholds Th₁, . . . , Thₚ (e.g., Th₁< . . . <Thₚ) and a plurality of adjustment coefficients d₁, . . . , dₚ (e.g., d₁< . . . <dₚ) may be used.

### (iv) Fourth Pattern

The approach for modifying the weight w₂ⱼ based on the priority of each of a plurality of instances in the past has been described in the second pattern, and the approach for modifying the weight w₂ⱼ based on the number n of kernel functions α associated with an instance currently being executed has been described in the third pattern. In the fourth pattern, the kernel density estimation unit 4 may execute the second and third patterns in combination.

For example, the kernel density estimation unit 4 may modify the weight w₂ⱼ based on the number n of kernel functions α associated with an instance currently being executed and the priority of each of a plurality of instances in the past, according to the following expression (10) which combines the above expressions (8) and (9).

$${w}_{2 j} = \{ \begin{matrix}\frac{N}{k * m} * c * j & ( n \leq Th ) \\ \frac{N}{k * m} * c * d * j & ( n > Th )\end{matrix} \qquad ( 10 )$$

### (D) Example of Operation of One Embodiment

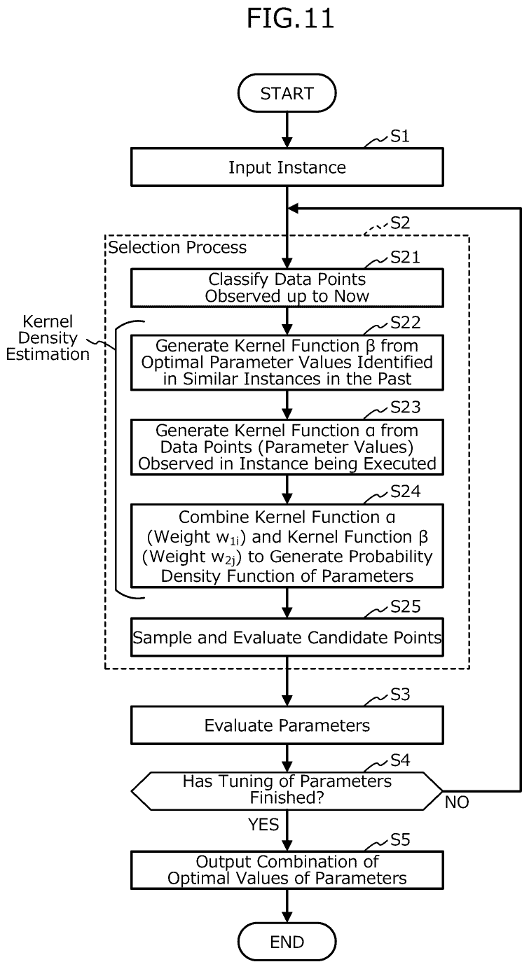

FIG. 11 is a flowchart illustrating an example of the operation of the optimization apparatus 1 according to one embodiment. It is assumed that the instance information 2a and the history information 2b have been stored in the memory unit 2.

In Step S1, an instance is input from the instance information 2a to the controller 8.

In Step S2 (S21 to S25), a selection process by the data point classification unit 3, the kernel density estimation unit 4, and the combination selection unit 5 is performed.

In Step S21, the data point classification unit 3 classifies (divides) data points observed up to now.

In Step S22, the kernel density estimation unit 4 generates kernel functions β from the optimal parameter values identified in a plurality of instances in the past (similar instances).

In Step S23, the kernel density estimation unit 4 generates kernel functions α from the data points (parameter values) observed in an instance currently being executed.

In Step S24, the kernel density estimation unit 4 combines the kernel functions α weighted by w₁ᵢ with the kernel functions β weighted by w₂ⱼ to generate the probability density function l(x) for the parameters. Additionally, the kernel density estimation unit 4 generates the probability density function g(x) for the parameters.

Note that Steps S22 and S23 may be executed in reverse order or may be executed in parallel to each other. Steps S22 to S24 represent one example of the kernel density estimation process.

In Step S25, the combination selection unit 5 performs sampling and evaluation of candidate points for each of the probability density functions l(x) and g(x). For example, the combination selection unit 5 selects the candidate point x⁺ where l(x⁺)/g(x⁺) is maximized from a plurality of candidate points x⁺. The combination selection unit 5 outputs the candidate points x⁺ selected for each parameter to the parameter evaluation unit 6, as a combination of parameter values.

In Step S3, the parameter evaluation unit 6 sets the selected combination of values of the plurality of parameters and performs a solution process for the optimization problem for the instance currently being executed. Based on the execution result, the values of the parameters are evaluated in the selected combination.

In Step S4, the parameter evaluation unit 6 determines whether or not the tuning of parameters has been finished. If the tuning has not been finished yet (NO in Step S4), the process proceeds to Step S2 (S21 to S25). If the tuning has been finished (YES in Step S4), the process proceeds to Step S5. The determination as to whether or not the tuning of the parameters has been finished may be made based on, for example, whether or not the evaluation result (an evaluation function value as one example) meeting the completion criteria is obtained in Step S3, or whether or not a given number of iterations has been performed, etc.

In Step S6, the output unit 7 outputs a combination of optimal values of the parameters identified by the parameter evaluation unit 6, e.g., a combination of values of the parameters that has yielded the best evaluation result in the evaluations of the parameters, as the optimal parameter values 2c, and the process ends. Note that the optimal parameter values 2c may be stored in the memory unit 2, for example.

As described above, according to the optimization apparatus 1 according to one embodiment, a plurality of optimal values of the parameters identified in a plurality of instances in the past, in addition to an instance currently being executed, are used when the probability density function l(x) is generated in the kernel density estimation. This enables efficient tuning of hyperparameters, achieving an improvement in the quality of the solution and reduction in tuning time.

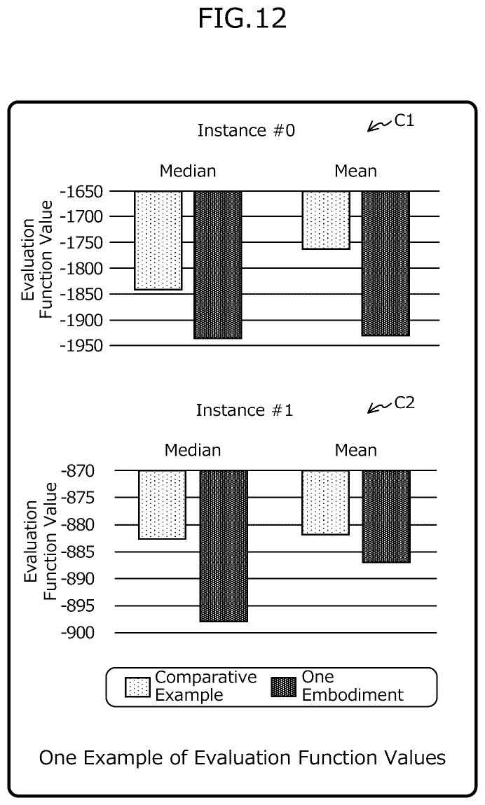

FIG. 12 is a diagram illustrating one example of evaluation function values obtained by the approach according to one embodiment. FIG. 12 compares the execution results of the tuning process using TPE as a comparative example, with the execution results of the tuning process that applies the approach according to one embodiment to TPE, for instances related to optimization problems in IT-driven drug discovery. In FIG. 12, the evaluation function values were calculated 10 times by setting the optimal combination of the values of parameters finally identified through tuning for both the comparison example and the approach according to one embodiment, and the medians and means of the measurement results were calculated. In the approach according to one embodiment, the optimal parameter values tuned in 27 instances in the past (m=27) were used.

As illustrated in FIG. 12, in both the examples of Instance #0 (denoted by Symbol C1) and Instance #1 (denoted by Symbol C2), the medians and means of evaluation function values for the approach according to one embodiment were better than those of the comparative example, confirming the effectiveness of improving the quality of the solution.

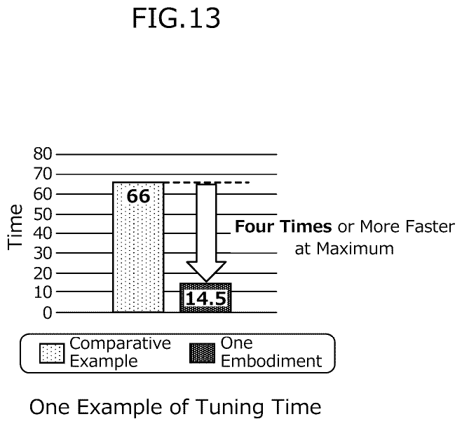

FIG. 13 is a diagram illustrating one example of the tuning time by the approach according to one embodiment. FIG. 13 depicts the comparison of the processing time between the processing time of the tuning process using TPE as a comparative example, and the processing time of the tuning process that applies the approach according to one embodiment to TPE. As illustrated in FIG. 13, according to the approach according to one embodiment, evaluation function values equivalent to those of the comparative example can be obtained in tuning time that is four times or more faster at maximum (one-fourth or less the time). This demonstrates the effectiveness of reducing tuning time through improved quality of the solution.

### (E) Miscellaneous

The technology according to one embodiment described above may be modified or changed as follows.

For example, the data point classification unit 3, the kernel density estimation unit 4, the combination selection unit 5, the parameter evaluation unit 6, and the output unit 7 provided in the optimization apparatus 1 illustrated in FIG. 9 may be combined in any combination or divided as needed.

Additionally, for example, the optimization apparatus 1 illustrated in FIG. 9 may have a configuration in which multiple apparatuses cooperate with each other via a network to embody each processing function. As one example, the data point classification unit 3, the kernel density estimation unit 4, the combination selection unit 5, the parameter evaluation unit 6, and the output unit 7 may be embodied by an application server or a web server, while the memory unit 2 may be embodied by a database (DB) server. In this case, the web server, the application server, and the DB server may cooperate with each other via a network to embody processing functions as the optimization apparatus 1.

In one aspect, values of a plurality of parameters to be used in an optimization algorithm can be identified efficiently.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a parameter identification program that causes a computer to execute a process comprising:
generating a probability density function for each of a plurality of parameters used in an optimization algorithm by combining a kernel function generated from a first value of the parameter observed in a given instance, and a kernel function generated from a second value of the parameter identified in each of a plurality of instances; and
identifying respective values of the plurality of parameters based on the probability density function generated for the each of the plurality of parameters.

2. The non-transitory computer-readable recording medium according to claim 1,
wherein the generating comprises
calculating the probability density function according to a calculation formula for the probability density function in a kernel density estimation process, the calculation formula comprising a plurality of the kernel functions generated based on a plurality of the first values of the parameter observed in the given instance and a plurality of the kernel functions generated based on a plurality of the second values of the parameter identified in the plurality of instances.

3. The non-transitory computer-readable recording medium according to claim 2,
wherein the generating comprises
calculating l(x) yielding the probability density function using the following formula (11) as the calculation formula:
$$l ( x ) = \frac{1}{{\sum }_{i = 1}^{n} {w}_{1 i} + {\sum }_{j = 1}^{m} {w}_{2 j}} \{ {\sum }_{i = 1}^{n} {w}_{1 i} \frac{1}{\sqrt{2 π} h} exp ( - \frac{{( x - {x}_{i} )}^{2}}{2 {h}^{2}} ) + {\sum }_{j = 1}^{m} {w}_{2 j} \frac{1}{\sqrt{2 π} h} exp ( - \frac{{( x - {x}_{j} )}^{2}}{2 {h}^{2}} ) \} \qquad ( 11 )$$
in the formula (11),
x is the first value of the parameter;
n is a number of values of the parameter observed in the given instance;
w₁ᵢ is a weight given to each of values of the parameter observed in the given instance,
h is a bandwidth;
xᵢ is the value of the parameter observed in the given instance;
m is a number of the plurality of instances;
w₂ⱼ is a weight given to each of the plurality of instances; and
x₂ⱼ is the second value of the parameter identified in each of the plurality of instances.

4. The non-transitory computer-readable recording medium according to claim 1,
wherein the generating comprises
calculating a weight to be multiplied by the kernel function generated from the second value based on a number of values of the parameter observed in the given instance and a number of the plurality of instances.

5. The non-transitory computer-readable recording medium according to claim 4,
wherein the calculating the weight comprises
adjusting a value of the weight to be multiplied by each of a plurality of the kernel functions generated based on a plurality of the second values of the parameter identified in the plurality of instances, according to priorities of each of the plurality of instances.

6. The non-transitory computer-readable recording medium according to claim 4,
wherein the calculating the weight comprises
adjusting the value of the weight to be multiplied by each of the plurality of kernel functions generated based on the plurality of second values of the parameter identified in the plurality of instances, according to a number of a plurality of the kernel functions generated based on a plurality of the first values of the parameter observed in the given instance.

7. The non-transitory computer-readable recording medium according to claim 4,
wherein the calculating the weight comprises
adjusting the value of the weight to be multiplied by each of the plurality of kernel functions generated based on the plurality of second values of the parameter identified in the plurality of instances, according to a priority of each of the plurality of instances and a number of a plurality of the kernel functions generated from a plurality of the first values of the parameter observed in the given instance.

8. The non-transitory computer-readable recording medium according to claim 1,
wherein the process comprises
outputting a combination of the identified respective values of the plurality of parameters as setting values of hyperparameters to be set in a solution process of the given instance.

9. The non-transitory computer-readable recording medium according to claim 1,
wherein the plurality of parameters identified based on the probability density function are parameters used to search for a solution in the given instance using the optimization algorithm.

10. A computer-implemented parameter identification method that causes a computer to execute a process comprising:
generating a probability density function for each of a plurality of parameters used in an optimization algorithm by combining a kernel function generated from a first value of the parameter observed in a given instance, and a kernel function generated from a second value of the parameter identified in each of a plurality of instances; and
identifying respective values of the plurality of parameters based on the probability density function generated for the each of the plurality of parameters.

11. The computer-implemented parameter identification method according to claim 10,
wherein the generating comprises
calculating the probability density function according to a calculation formula for the probability density function in a kernel density estimation process, the calculation formula comprising a plurality of the kernel functions generated based on a plurality of the first values of the parameter observed in the given instance and a plurality of the kernel functions generated based on a plurality of the second values of the parameter identified in the plurality of instances.

12. The computer-implemented parameter identification method according to claim 11,
wherein the generating comprises
calculating l(x) yielding the probability density function using the following formula (12) as the calculation formula:
$$l ( x ) = \frac{1}{{\sum }_{i = 1}^{n} {w}_{1 i} + {\sum }_{j = 1}^{m} {w}_{2 j}} \{ {\sum }_{i = 1}^{n} {w}_{1 i} \frac{1}{\sqrt{2 π} h} exp ( - \frac{{( x - {x}_{i} )}^{2}}{2 {h}^{2}} ) + {\sum }_{j = 1}^{m} {w}_{2 j} \frac{1}{\sqrt{2 π} h} exp ( - \frac{{( x - {x}_{j} )}^{2}}{2 {h}^{2}} ) \} \qquad ( 12 )$$
in the formula (12),
x is the first value of the parameter;
n is a number of values of the parameter observed in the given instance;
w₁ᵢ is a weight given to each of values of the parameter observed in the given instance,
h is a bandwidth;
xᵢ is the value of the parameter observed in the given instance;
m is a number of the plurality of instances;
w₂ⱼ is a weight given to each of the plurality of instances; and
x₂ⱼ is the second value of the parameter identified in each of the plurality of instances.

13. The computer-implemented parameter identification method according to claim 10,
wherein the generating comprises
calculating a weight to be multiplied by the kernel function generated from the second value based on a number of values of the parameter observed in the given instance and a number of the plurality of instances.

14. The computer-implemented parameter identification method according to claim 13,
wherein the calculating the weight comprises
adjusting a value of the weight to be multiplied by each of a plurality of the kernel functions generated based on a plurality of the second values of the parameter identified in the plurality of instances, according to priorities of each of the plurality of instances.

15. The computer-implemented parameter identification method according to claim 13,
wherein the calculating the weight comprises
adjusting the value of the weight to be multiplied by each of the plurality of kernel functions generated based on the plurality of second values of the parameter identified in the plurality of instances, according to a number of a plurality of the kernel functions generated based on a plurality of the first values of the parameter observed in the given instance.

16. The computer-implemented parameter identification method according to claim 13,
wherein the calculating the weight comprises
adjusting the value of the weight to be multiplied by each of the plurality of kernel functions generated based on the plurality of second values of the parameter identified in the plurality of instances, according to a priority of each of the plurality of instances and a number of a plurality of the kernel functions generated from a plurality of the first values of the parameter observed in the given instance.

17. The computer-implemented parameter identification method according to claim 10,
wherein the process comprises
outputting a combination of the identified respective values of the plurality of parameters as setting values of hyperparameters to be set in a solution process of the given instance.

18. An information processing apparatus comprising:
a memory; and
a processor coupled to the memory, the processor being configured to perform a process comprising
generating a probability density function for each of a plurality of parameters used in an optimization algorithm by combining a kernel function generated from a first value of the parameter observed in a given instance, and a kernel function generated from a second value of the parameter identified in each of a plurality of instances, and
identifying respective values of the plurality of parameters based on the probability density function generated for the each of the plurality of parameters.

19. The information processing apparatus according to claim 18,
wherein, in the generating, the processor
calculates the probability density function according to a calculation formula for the probability density function in a kernel density estimation process, the calculation formula comprising a plurality of the kernel functions generated based on a plurality of the first values of the parameter observed in the given instance and a plurality of the kernel functions generated based on a plurality of the second values of the parameter identified in the plurality of instances.

20. The information processing apparatus according to claim 19,
wherein, in the generating, the processor
calculates l(x) yielding the probability density function using the following formula (13) as the calculation formula:
$$l ( x ) = \frac{1}{{\sum }_{i = 1}^{n} {w}_{1 i} + {\sum }_{j = 1}^{m} {w}_{2 j}} \{ {\sum }_{i = 1}^{n} {w}_{1 i} \frac{1}{\sqrt{2 π} h} exp ( - \frac{{( x - {x}_{i} )}^{2}}{2 {h}^{2}} ) + {\sum }_{j = 1}^{m} {w}_{2 j} \frac{1}{\sqrt{2 π} h} exp ( - \frac{{( x - {x}_{j} )}^{2}}{2 {h}^{2}} ) \} \qquad ( 13 )$$
in the formula (13),
x is the first value of the parameter;
n is a number of values of the parameter observed in the given instance;
w₁ᵢ is a weight given to each of values of the parameter observed in the given instance,
h is a bandwidth;
xᵢ is the value of the parameter observed in the given instance;
m is a number of the plurality of instances;
w₂ⱼ is a weight given to each of the plurality of instances; and
x₂ⱼ is the second value of the parameter identified in each of the plurality of instances.
